(19) United States
(12) Patent Application Publication
(10) Pub. No.: US 2019/0129958 A1
(43) Pub. Date: May 2, 2019

(54) Optimizing the Mapping of Qualitative Labels to Scores for Calculating Gain in Search Results

(71) Applicant: Facebook, Inc., Menlo Park, CA (US)

(72) Inventor: Zhen Liao, Sunnyvale, CA (US)

(21) Appl. No.: 15/797,435

(22) Filed: Oct. 30, 2017

(51) Int. Cl. G06F 17/30; G06N 99/00; G06N 5/04

(52) U.S. Cl. CPC G06F 17/3053; G06N 5/04; G06N 99/005

(57) ABSTRACT

In one embodiment, a method includes receiving, from a client system, qualitatively-labeled search results, determining, based on an initial mapping scheme that maps the qualitative labels to an initial set of scores, an initial score for each of the search results, calculating an initial normalized discounted cumulative gain (nDCG) for the search results, generating a new mapping scheme that maps the qualitative labels to a new set of scores, and includes one or more pairs of non-consecutive scores, where a new nDCG calculated for the new search results is greater than the initial nDCG, determining, based on the new mapping scheme, a new score for each of the search results, and generating a new ranking algorithm based on the new set of scores, wherein the new ranking algorithm ranks the search results to improve the nDCG for each set of qualitatively-labeled search results.

### TECHNICAL FIELD

This disclosure generally relates to use of machine learning for processing online search results.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, in a search system based on machine learning, in which quantitative labels such as “relevant” or “off-topic” are assigned to training data and mapped to numeric scores for ranking the search results, the quality of the search result rankings may be improved by generating a mapping of labels to scores in which adjacent labels, e.g., pairs of labels corresponding to similar levels of quality, are mapped to non-consecutive score values. For example, such a mapping may be modified to map high, medium, and low quality labels to the non-consecutive scores 6, 3, and 1, respectively, instead of to the consecutive scores 3, 2, and 1. The resulting larger differences between adjacent scores may allow the machine-learning model to more effectively determine the difference between different types of content when ranking search results, and thereby rank the search results more accurately. The search results may be, for example, web pages or other types of content objects. As an example, using a mapping to consecutive scores, a content object labeled as low quality may improperly be ranked higher in the search results than a content object labeled as medium quality, even though the scores to which the objects are mapped indicate that the ranking model has improperly reversed the order of the search results. Improper rankings may occur because similar score values, such as consecutive score values that correspond to different quality levels, may result in reversals in the ranking model, for example.

In particular embodiments, a solution may include mapping the labels to a wider range of non-consecutive numerical scores, e.g., by mapping high, medium, and low quality labels to 6, 3, and 1, respectively, instead of to 3, 2, and 1. The resulting larger differences between adjacent scores may allow the machine-learning model to more effectively determine the difference between different types of content when ranking search results.

In particular embodiments, a ranking model may be trained based on two or more labels assigned to each search result by a human user, and the labels for each search result may be mapped to a single numeric score of the search result. Labels may indicate the quality of the search result such as, for example, the relevance of a search result, e.g., highly relevant or off-topic, or the opinion quality of a search result, e.g., that the search result contains a good-quality opinion or no detectable opinion, or other measure of the quality of a search result.

In existing ranking systems, such as those used in search engines implemented by computer systems, a range of labels corresponding to a range of search result quality, such as high, medium, and low quality, may be mapped to a range of numeric scores, such as 3, 2, and 1, respectively, as introduced above. The scores may be used in a ranking model to rank the search results. This mapping may lead to a problem in which two content objects may be ranked similarly and possibly reversed in the ranking because of the similarity in their scores. For example, a low-quality content object may be inappropriately ranked higher than a medium-quality content object because the low- and medium-quality objects are mapped to scores of 1 and 2, respectively, which may result in confusion in the machine-learning model. The machine-learning model may be unable to effectively learn the difference between these two types of content because of the similarity between the two scores, which may lead to similar values from a loss function during the learning process. As an example, in a learned ranking model that uses Nondeterministic Discounted Cumulative Gain (nDCG) to evaluate the quality of search results, the nDCG values for two content objects having similar scores may be sufficiently close that the ranking model generates a ranking in which the order of the content objects is the reverse of the order that is expected based on their scores.

Thus, the content object having low quality may be ranked higher than the content object having medium quality in the search results, even though the scores to which the objects are mapped indicate that the object having medium quality should be ranked higher than the object having low quality. In particular embodiments, a solution may include mapping the labels to a wider range of non-consecutive numerical scores, e.g., by mapping high, medium, and low quality to 6, 3, and 1, respectively, instead of to 3, 2, and 1. The resulting larger differences between adjacent scores may allow the machine-learning model to more effectively determine the difference between different types of content when ranking search results.

In particular embodiments, search result labels may be grouped into levels, e.g., a high-quality label, three medium-quality labels, and a low-quality label, and the labels within levels may be ordered, e.g., the medium-quality labels may include a lowest medium-quality label, a middle medium-quality label, and a highest medium-quality label. Adjacent labels in different levels, e.g., between the high-quality label and the highest medium-quality label, may be mapped to non-consecutive scores, e.g., to 15 and 12, respectively. Adjacent labels within a level, e.g., the highest medium-quality label and the middle medium-quality label, may also be mapped to non-consecutive scores, but with a smaller difference than the difference between adjacent labels in different groups. For example, the highest, middle, and lowest medium-quality labels may be mapped to the scores 12, 11, and 9, respectively, and the low-quality label may be mapped to the score 1. The quality of search result rankings may be improved by increasing the numeric difference between consecutive scores that correspond to different but adjacent levels of search result quality.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system including features for ranking search results.

FIG. 2A illustrates example search results.

FIG. 2B illustrates an example mapping of qualitative labels to scores.

FIG. 2C illustrates example search results generated using the label-to-score mapping of FIG. 2B.

FIGS. 3A-3F illustrate example mappings of qualitative labels to scores and corresponding example search results.

FIGS. 4A and 4B illustrate example quality levels.

FIG. 5 illustrates example probability distributions corresponding to example label-to-score mappings.

FIG. 6 illustrates an example method for improving search result rankings.

FIG. 7 illustrates an example social graph.

FIG. 8 illustrates an example computer system.

### DESCRIPTION OF EXAMPLE EMBODIMENTS

### System Overview

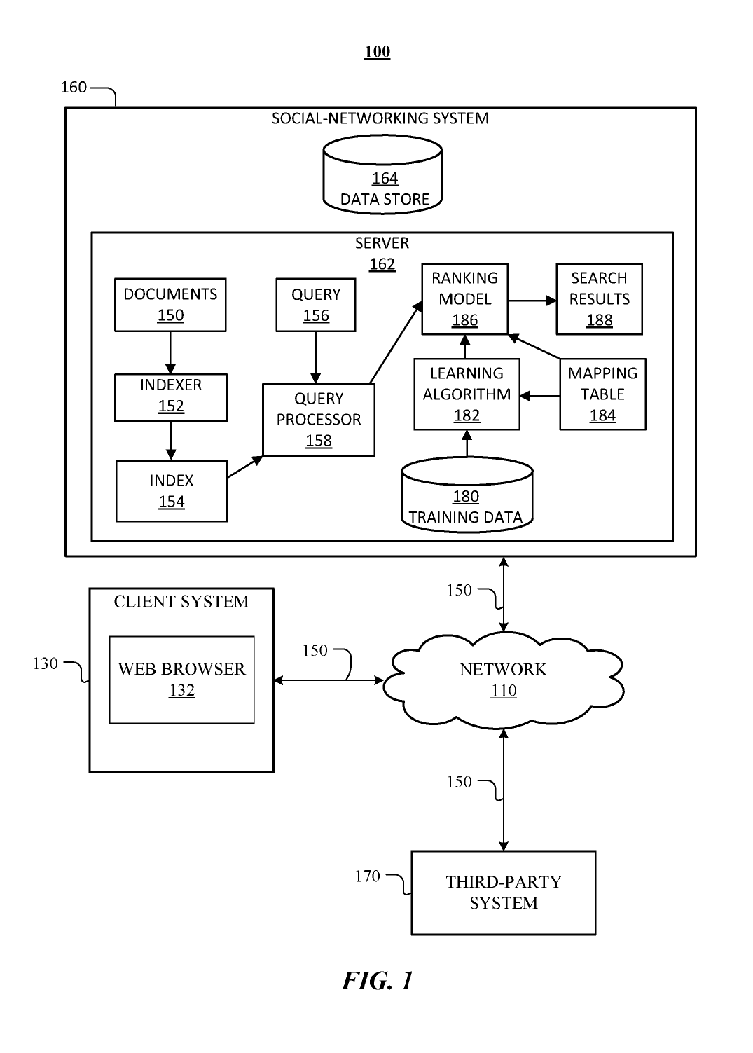

FIG. 1 illustrates an example network environment 100 associated with a social-networking system including features for ranking search results. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Search Queries on Online Social Networks

In particular embodiments, a user may submit a query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763162, filed 19 Apr. 2010, and U.S. patent application Ser. No. 13/556072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, and U.S. patent application Ser. No. 12/978265, filed 23 Dec. 2010, which are incorporated by reference.

Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556072, filed 23 Jul. 2012, U.S. patent application Ser. No. 13/731866, filed 31 Dec. 2012, and U.S. patent application Ser. No. 13/732101, filed 31 Dec. 2012, each of which is incorporated by reference. More information on structured search queries and grammar models may be found in U.S. patent application Ser. No. 13/556072, filed 23 Jul. 2012, U.S. patent application Ser. No. 13/674695, filed 12Nov. 2012, and U.S. patent application Ser. No. 13/731866, filed 31 Dec. 2012, each of which is incorporated by reference.

Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244748, filed 3 Apr. 2014, U.S. patent application Ser. No. 14/470607, filed 27 Aug. 2014, and U.S. patent application Ser. No. 14/561418, filed 5 Dec. 2014, each of which is incorporated by reference.

### Optimizing the Mapping of Qualitative Labels to Scores

In particular embodiments, in a search system based on machine learning, in which quantitative labels such as “relevant” or “off-topic” are assigned to training data and mapped to numeric scores for ranking the search results, the quality of search result rankings may be improved by generating a mapping of labels to scores in which adjacent labels, e.g., pairs of labels corresponding to similar levels of quality, are mapped to non-consecutive score values. For example, such a mapping may be modified to map high, medium, and low quality labels to the non-consecutive scores 6, 3, and 1, respectively, instead of to the consecutive scores 3, 2, and 1. The resulting larger differences between adjacent scores may allow the machine-learning model to more effectively determine the difference between different types of content when ranking search results, and thereby rank the search results more accurately. The search results may be, for example, web pages or other types of content objects. As an example, using a mapping to consecutive scores, a content object labeled as low quality may improperly be ranked higher in the search results than a content object labeled as medium quality, even though the scores to which the objects are mapped indicate that the ranking model has improperly reversed the order of the search results. Improper rankings may occur because similar score values may result in reversals in the ranking model, for example.

In particular embodiments, a solution may include mapping the labels to a wider range of non-consecutive numerical scores, e.g., by mapping high, medium, and low quality labels to 6, 3, and 1, respectively, instead of to 3, 2, and 1. The resulting larger differences between adjacent scores may allow the machine-learning model to more effectively determine the difference between different types of content when ranking search results.

In particular embodiments, a ranking model may be trained based on two or more labels assigned to each search result by a human user, and the labels for each search result may be mapped to a single numeric score of the search result. Labels may indicate the quality of the search result such as, for example, the relevance of a search result, e.g., highly relevant or off-topic, or the opinion quality of a search result, e.g., that the search result contains a good-quality opinion or no detectable opinion, or other measure of the quality of a search result.

In existing ranking systems, such as those used in search engines implemented by computer systems, a range of labels corresponding to a range of search result quality, such as high, medium, and low quality, may be mapped to a range of numeric scores, such as 3, 2, and 1, respectively, as introduced above. The scores may be used in a ranking model to rank the search results. This mapping may lead to a problem in which two content objects may be ranked similarly and possibly reversed in the ranking because of the similarity in their scores. For example, a low-quality content object may be inappropriately ranked higher than a medium-quality content object because the low- and medium-quality objects are mapped to scores of 1 and 2, respectively, which may result in confusion in the machine-learning model. The machine-learning model may be unable to effectively learn the difference between these two types of content because of the similarity between the two scores, which may lead to similar values from a loss function during the learning process. As an example, in a learned ranking model that uses Nondeterministic Discounted Cumulative Gain (nDCG) to evaluate the quality of search results, the nDCG values for two content objects having similar scores may be sufficiently close that the ranking model generates a ranking in which the order of the content objects is the reverse of the order that is expected based on their scores.

Thus, the content object having low quality may be ranked higher than the content object having medium quality in the search results, even though the scores to which the objects are mapped indicate that the object having medium quality should be ranked higher than the object having low quality. In particular embodiments, a solution may include mapping the labels to a wider range of non-consecutive numerical scores, e.g., by mapping high, medium, and low quality to 6, 3, and 1, respectively, instead of to 3, 2, and 1. The resulting larger differences between adjacent scores may allow the machine-learning model to more effectively determine the difference between different types of content when ranking search results.

In particular embodiments, search result labels may be grouped into levels, e.g., a high-quality label, three medium-quality labels, and a low-quality label, and the labels within levels may be ordered, e.g., the medium-quality labels may include a lowest medium-quality label, a middle medium-quality label, and a highest medium-quality label. Adjacent labels in different levels, e.g., between the high-quality label and the highest medium-quality label, may be mapped to non-consecutive scores, e.g., to 15 and 12, respectively. Adjacent labels within a level, e.g., the highest medium-quality label and the middle medium-quality label, may also be mapped to non-consecutive scores, but with a smaller difference than the difference between adjacent labels in different groups. For example, the highest, middle, and lowest medium-quality labels may be mapped to the scores 12, 11, and 9, respectively, and the low-quality label may be mapped to the score 1. The quality of search result rankings may be improved by increasing the numeric difference between consecutive scores that correspond to different but adjacent levels of search result quality.

In particular embodiments, referring to FIG. 1, a server 162 may generate ranked search results 188. The server 162 may include search engine components, such as an indexer 152, which may receive documents 150 to be searched, and may generate an index 154 of the documents. A learning algorithm 182, e.g., a “learning to rank” algorithm such as LambdaMART, may receive training date 180, which may include sample search results labeled by human trainers. The learning algorithm 182 may generate a ranking model 186 using a mapping table 184 to map the labels associated with the training data 180 to numeric scores. To generate search results, a query processor 158 may receive a query 156 and use the index 154 to identify documents 150 that match the query 156. The ranking model 186 may generate ranked search results 188, e.g., in order of quality, using the mapping table 184 to map labels in the search results to numeric scores for use in determining the rankings. The training data 180 may include text labeled with relevance levels and opinion levels assigned by human trainers. For example, a human trainer may be presented with a query and a search result, and asked to provide the corresponding relevance and opinion quality levels. A numeric label in the range 1-9 (in this example) may then be determined from the trainer's input according to the mapping and assigned to the query and search result for use in training the model. The learning algorithm 182 that performs the training process may be implemented in Python code, for example. The trained ranking model 186 may execute whenever search results are ranked and may be implemented in C++ code, for example.

In particular embodiments, the number of ranked search results 188 presented as output (e.g., to a user) may be limited by a threshold value, such as a threshold number of search results 188 or a threshold ranking score. The number of presented search results 188 may be limited to a threshold number such as 3, 10, 20, 100, or the like. Alternatively or additionally, a threshold score for search results 188 to be presented as output may be used, e.g., a threshold score of 6, in which case results having a score of 6 or greater are included in the output, and search results 188 having a score of less than 6 are not included. Other values of the threshold score may be used, e.g., 5 instead of 6, or 5.5.

In particular embodiments, a search result ranking system may be trained based on two or more labels assigned to each training search result in a training data set by a human user, and the labels for each training search result may be mapped to a single numeric score of the training search result. Labels may indicate the quality of the training search result. For example, a label may indicate a relevance of the training search result to the query 156, e.g., highly relevant or off-topic, or an opinion quality of the search result, e.g., that the training search result contains a good-quality opinion or no detectable opinion, or other measure of the quality of a search result. The quality of search result rankings generated by the trained ranking model 186 may be improved by increasing the numeric difference between consecutive scores that correspond to different but adjacent levels of search result quality.

For example, for each training search result in a set of training data 180, a human trainer may indicate the level of relevance of the search result's content to a query by labeling the search result as “reasonably relevant” or “off-topic.” As another example, the human trainer may indicate the level of opinion content in each training search result by labeling the search result as “good opinion content” or “bad opinion content.”

In particular embodiments, a machine-learned ranking model 186 for ranking search results 188 may be trained based on the labeled search results. The machine-learned ranking model 186 may use a “learning to rank” technique, e.g., LambdaMART or the like, which may generated ranked search results 188 based on associated quality scores. LambdaMART may use Gradient Boosted Regression Trees to attempt to optimize loss functions such as Normalized Discounted Cumulative Gain (nDCG) that are customized for ranking models. Gradient Boosted Regression Trees are also known as Multiple Additive Regression Trees (MART). LambdaMART may calculate “lambda” values for each training point pair, and uses the lambda values as the gradient values in the Gradient Boosted Regression Trees.

In particular embodiments, the labels associated with each search result, which may be referred to herein as qualitative labels, may be mapped to a numeric score by the mapping table 184, and the score may be provided to the ranking model for ranking the search results. Thus, when each search result is associated with a plurality of labels (e.g., two labels), a mapping operation may be performed to map the labels to a single numeric score. The score may be proportional to the level of search result quality represented by the plurality of labels. For example, using the example labels described above, there are two sets of labels: the content-relevance labels and the opinion-quality labels. The content-relevance labels include the “reasonably relevant” and “off-topic” labels, and the opinion-quality labels include the “good opinion content” and “bad opinion content” labels. A search result may have one label from each set, so there are four possible combinations of labels. Each combination may be mapped to a different numeric score, as shown in Table 1 below.

The mapping shown in Table 1 maps the tuple (good opinion, reasonably relevant) to the score 4, (bad opinion, reasonably relevant) to 3, (good opinion, off-topic) to 2, and (bad opinion, off-topic) to 1. In this mapping, the scores are consecutive numbers in the range 1 through 4. Using such consecutive scores with machine-learned ranking models may result in sub-optimal ranked results 188, however. The ranking model may rank a (bad-opinion, off-topic) search result higher than a (good, opinion, off-topic) search result because of the similarity of the corresponding scores (2 and 1, respectively), but such a reversal is undesirable because of the difference in meaning between (bad-opinion, off-topic) and (good opinion, off-topic). Such reversals may occur for various reasons, such as errors in the training data 180 or other issues. A mapping 184 from qualitative labels to numerical scores that places the scores for different quality levels relatively close to each other may lead to the machine-learning algorithm 182 being unable to effectively learn the difference between these two types of content. The similar scores may produce similar values from a loss function during the learning process, so the two content items may be ranked similarly, and possibly reversed in the ranked search results 188.

TABLE 1

| | Reasonably relevant | Off-topic |
|---|---|---|
| Good opinion | 4 | 2 |
| Bad opinion | 3 | 1 |

In particular embodiments, a (bad-opinion, off-topic) search result may be considered a low-quality search result, but a (good opinion, off-topic) search result may be considered a medium-quality search result that should be ranked higher than a low-quality search result. Reversals of search results having the same quality level may be acceptable, however. For example, a (bad-opinion, reasonably relevant) search result, having a score of 3, and a (good opinion, off-topic) search result, having a score of 2, may both be considered medium-quality search results, so a reversal of these two search results may be acceptable. The fourth label combination, (good opinion, reasonably relevant), having a score of 4, may be considered a high-quality search result because both labels are high-quality (both labels correspond to the highest quality in their respective label sets). A reversal may occur between a (bad-opinion, reasonably relevant) search result (score=3) and a (good opinion, reasonably relevant) search result (score=4) because of the similarity in the corresponding scores. Such a reversal may be undesirable because it causes a medium-quality search result to be ranked above a high-quality search result.

In particular embodiments, to avoid undesirable reversals such as those described in the examples above, numeric gaps between scores may be introduced in the mapping 184 from qualitative labels to scores. A gap may be introduced between each pair of adjacent scores that correspond to different quality levels. For example, as described in the example above, the score 1 corresponds to a low-quality level, the scores 2 and 3 correspond to a medium-quality level, and the score 4 corresponds to a high-quality level. Thus, a gap may be introduced between scores 1 and 2, because scores 1 and 2 are adjacent (e.g., there are no other scores between 1 and 2), and correspond to different quality levels (e.g., the score of 1 corresponds to the high-quality level and the score of 2 corresponds to the medium-quality level). The size of the gap may be, e.g., 3, 4, 5, or other appropriate value. The size of the gap may be determined based on the difference between consecutive scores, e.g., as 3 or 4 multiples by the difference between consecutive scores. If the scores have different values, e.g., 10 instead of 1 and 30 instead of 2, then the scores may be normalized to consecutive values such as 1 and 2 before introducing gaps, or the gaps may be determined based on the differences between the scores, e.g., by a value based on the order of magnitude of the scores, such as 30 or 40 for the scores 10 and 30, or 300 or 400 for the scores 300 and 500. Introducing gaps of size 3 between scores corresponding to different quality levels in the examples above results in the mapping table shown in Table 2 below.

TABLE 2

| | Reasonably relevant | Off-topic |
|---|---|---|
| Good opinion | 8 | 4 |
| Bad opinion | 5 | 1 |

The mapping shown in Table 2 maps the tuple (good opinion, reasonably relevant) to the score 8, (bad opinion, reasonably relevant) to 5, (good opinion, off-topic) to 4, and (bad opinion, off-topic) to 1. In this mapping, scores corresponding to different adjacent quality levels are non-consecutive, with a difference of 3 between such scores. Adjacent scores corresponding to the same quality level are consecutive, being separated by a difference of 1.

Using such non-consecutive scores between quality levels with machine-learned ranking models may reduce the occurrence of sub-optimal rankings in which search results 188 are reversed. For example, the ranking model may be less likely to rank a (bad-opinion, off-topic) search result (score=1) higher than a (good, opinion, off-topic) search result (score=4), because the because the respective scores are separated by a gap of 3. The results of modifying the mapping 184 used by the ranking model by introducing gaps between scores may be evaluated calculating an initial discounted cumulative gain (DCG) for search results 188 generated for a query 156 using the unmodified mapping 184, then performing the query again and calculating a new DCG for the search results generated for the query 156 using the modified mapping 186. The DCG may be calculated for a portion of the search results 188, e.g., the top-K results, where K is a number such as 5, 10, 15, or the like. If the new DCG is greater than the initial DCG, then the modified mapping 184 has increased the quality of the search results and may be used subsequently to rank search results 188 for other queries 156. Otherwise, if the new DCG is not greater than the initial DCG, then the modified mapping 184 has not increased the quality of the search results 188, and a different mapping 184 may be generated and measured using another DCG calculation. The different mapping 184 may be generated by increasing the gap, e.g., from 3 to 5. The DCGs may be calculated for a set of queries 156, and the results for the set may be evaluated to determine whether to use the new mapping 184 in place of the initial mapping 184. For example, if the new DCG is greater by at least 5% for 80% of the new queries and decreased by less than 10% for the remaining 20% of the new queries, then the new mapping 184 may be used in place of the initial mapping 184 for subsequent queries 156.

In particular embodiments, although the DCG comparison may indicate that the quality of ranked search results 188 has improved, the quality of the search results may have decreased according to other criteria. As the scores for high-quality search results 188 are increased by introducing gaps, the high-quality search results may dominate the DCG calculation. For example, a high-quality score of 10 may result in a high DCG value for a top-K list of search results 188 that include low-quality search results. However, low-quality search results are less desirable than medium-quality and high-quality search results. Thus, a list of top-K search results 188 that contains low-quality search results may be of overall lower quality than another list of top-K search results (produced by a different mapping) that has a lower DCG but does not contain any low-quality search results. A similar condition based on an increase in the number of medium-quality search results and a decrease in the number of high-quality search results (with no low-quality search results) may also be used. In particular embodiments, if the number of low-quality search results in the top-K search results 188 increases as a result of a new mapping, then the new mapping 184 should not be used in place of the initial mapping 184, even if the DCG of the new mapping 184 is greater than the DCG of the initial mapping 184. In addition or alternatively, if the number of high-quality search results in the top-K search results 188 decreased as a result of a new mapping (while the number of low-quality search results is zero in the initial and new search results), then the new mapping 184 should not be used in place of the initial mapping, even if the DCG of the new mapping is greater.

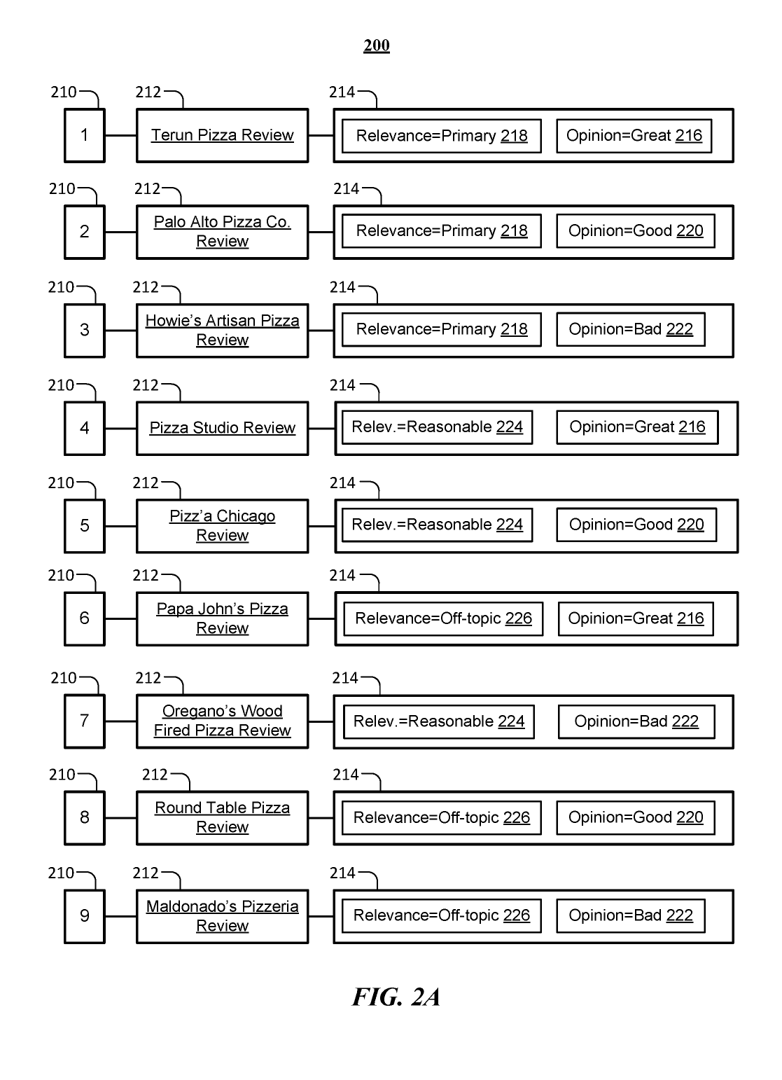

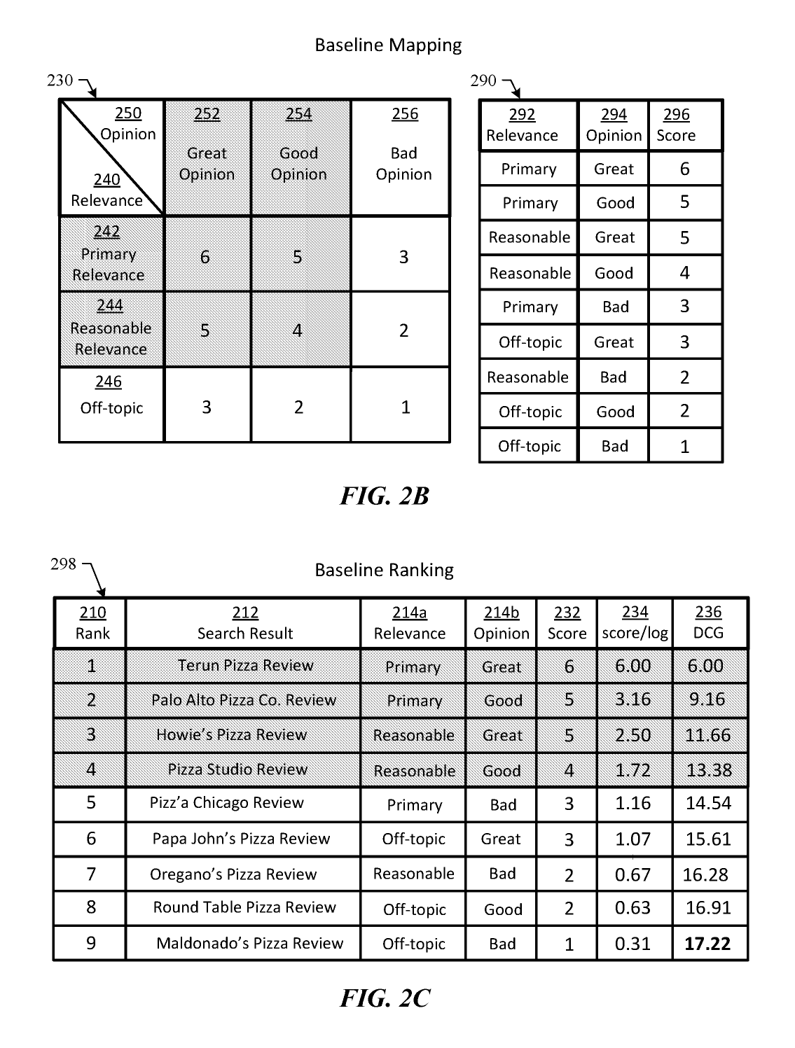

FIG. 2A illustrates an example list of search results 200. Each search result 212 may include content such as a document or a link to a document. In this example, each search result 212 includes a link to a review of a pizza restaurant. The search results 212 may have been generated in response to a query such as “pizza nearby” and are ordered based on qualitative labels 214 that indicate quality of associated reviews according to a measure of content relevance and a measure of opinion quality. Each search result 212 may be associated with a ranking 210, which indicates the position of the associated search 212 result in the ranked list of search results 200. For example, the highest-ranking search result 212 is named “Terun Pizza Review” and is associated with a ranking value 210 of “1” which indicates that the highest-ranking search result is ranked 1st in the list of search results 200. The highest-ranking search result 212 may also be referred to herein as the highest-quality search result. The lowest-ranking search result 212 is named “Maldonado's Pizzeria Review” and is associated with a ranking value 210 of “9” which indicates that the lowest-ranking search result is ranked 9th in the list of search results 200. Each search result 212 is associated with qualitative labels 214, including a content-relevance label and an opinion-quality label. Each content-relevance label may have the value “primary” indicating a high level of relevance, “reasonable” indicating a medium level of relevance, and “off-topic” indicating a low level of relevance. Each opinion-quality label may have the value “great” indicating content that contains a high level of opinion quality (e.g., the content most likely includes a meaningful opinion), “good” indicating content that contains a medium level of opinion quality (e.g., the content probably includes an opinion), or “bad” indicating content that contains a low level of opinion quality (e.g., the content probably does not include an opinion).

For example, in a search for “BMW” a primary content-relevance result may be directly related to BMW cars, a reasonable result may be related information about cars in general, and so on, and an off-topic result may be unrelated, e.g., a content item about a different topic. The level of opinion quality may be a measure of “interestingness” of a content item. Opinion quality may also be referred to as utility or comment quality. A great opinion may have high opinion quality, and may be content that is interesting, original, inoffensive, promotional, or viral. A good opinion may be good to know, but not as insightful or interesting as Great content. A sentiment such as “This is a great article about BMW” may be a good opinion. A bad opinion may have little to no information or utility to a user. Examples of bad opinions may include a re-share of an article with no text, a share with minimal text such as “BMW” or a random statement such as “Party on Saturday.” As another example, for the search query “BMW,” a review that compares a BMW car to other brands and describes the benefits, prices, and so on may be labeled as a great opinion. A good opinion may be a description of a personal experience driving a car. A bad opinion may be “This is fancy,” which may have little to no utility.

In particular embodiments, each of the search results 212 may be associated with a different combination of the two labels 214. The “Terun Pizza Review” search result 212 has a primary relevance label 218 and a great opinion label 216. Since those two labels are the highest-quality content-relevance and opinion-quality labels, respectively, the “Terun Pizza Review” is the highest-ranked search result in the list 200. The “Palo Alto Pizza Co. Review” search result 212 has a primary relevance label 218 and a good opinion label 216. Since one of those labels is the highest-quality content-relevance label and one is the second-highest-quality opinion quality respectively, the “Palo Alto Pizza Co. Review” is the second-highest-ranked search result. The “Howie's Artisan Pizza Review” search result 212 has a primary relevance label 218 and a bad opinion label 222, and is the third-highest-ranked search result, though other search results 212 in the list 200 may be better candidates for the third-highest-ranked search result. The “Pizza Studio Review” search result 212 has a reasonable relevance label 224 and a great opinion label 216, and is the fourth-highest-ranked search result. The “Pizz'a Chicago Review” search result 212 has a reasonable relevance label 224 and a good opinion label 220, and is the fifth-highest-ranked search result. The “Papa John's Pizza Review” search result 212 has an off-topic relevance label 226 and a great opinion label 216, and is the sixth-highest-ranked search result. The “Oregano's Wood Fired Pizza Review” search result 212 has a reasonable relevance label 224 and a bad opinion label 222, and is the seventh-highest-ranked search result. The “Round Table Pizza Review” search result 212 has an off-topic relevance label 226 and a good opinion label 220, and is the eighth-highest-ranked search result. The “Maldonado's Pizzeria Review” search result 212 has an off-topic relevance label 226 and a bad opinion label 222, and is the ninth-highest-ranked search result.

FIG. 2B illustrates an example mapping scheme 230 of qualitative labels to scores. The example mapping scheme 230 may correspond to the mapping table 184 of FIG. 1. The mapping scheme 230 may represent a baseline mapping in which each combination of qualitative labels is mapped to a different score. The scores of the baseline mapping scheme 230 may be used when comparing search results generated by mappings that have different score values for the qualitative labels, since DCG values calculated using different score values may not be directly comparable. The other mappings may use the same labels as the baseline mapping, so the baseline scores may be used to calculate DCG values for search results that are generated using different score values. The mapping scheme 230 has three columns for the three labels that represent opinion-quality 250: a great opinion column 252, a good opinion column 254, and a bad opinion column 256. The mapping scheme 230 also has three rows for the three labels that represent content-relevance 240: a primary relevance row 242, a reasonable relevance label 244, and an off-topic relevance label 246. The scores in the mapping scheme 230 include high-quality scores, which are shaded and correspond to high and medium-quality labels, and low-quality scores, which correspond to at least one low-quality label. The high-quality scores are: (primary, great)=6, (primary, good)=5, (reasonable, good)=4, and (reasonable, great)=5. The low-quality scores are (off-topic, great)=3, (primary, bad)=3, (off-topic, good)=2, (reasonable, bad)=2, and (off-topic, bad)=1. The baseline mapping scheme 230 is also shown as a mapping table 290 having a relevance label column 292, an opinion label column 294, and a score column 296. Variations on the mapping 300 are possible. For example, the mapping 300 shown values relevance quality more highly than opinion quality. The mapping shown assigns a score of 4 to a content item having the worst opinion quality but the best relevance quality, which is higher than the 3 assigned to a content item having the highest opinion quality but the lowest relevance quality. In an alternative mapping, the numbers 3 and 4 may be swapped if the reverse ordering is preferred, e.g., a content item having the lowest relevance quality and highest opinion quality is to be valued above a content item having medium relevance quality and the lowest opinion quality.

FIG. 2C illustrates example search results 298 generated using the baseline label-to-score mapping of FIG. 2B. The search results 298 are in the same order as the example search result list 200 of FIG. 2A. Each of the search results 298 is associated with a score 232 determined from a relevance label 214a and an opinion label 214b associated with the search result 212 using the mapping scheme 230. The scores 232 are in the order 6, 5, 5, 4, 3, 3, 2, 2, 1 from highest-ranking to lowest-ranking. A DCG 236 may be calculated for each ranking position (e.g., row) p 1 through 9 based on the score 232 at that row and the sum of the DCGs of lower-numbered rows according one of the following formulas:

$$D C {G}_{p} = {\sum }_{i = 1}^{p} \frac{{score}_{i}}{{log}_{2} ( i + 1 )} or D C {G}_{p} = {\sum }_{i = 1}^{p} \frac{{2}^{{score}_{i}} - 1}{{log}_{2} ( i + 1 )}$$

The first formula is used in the example calculations herein. The second formula may weight relevant documents more strongly, and may be used in an implementation. Referring to the first formula, the value of the quotient used for each term of the sum is shown in the score/log column 234. For example, the DCG of the highest-ranked search result (at rank 1) is 6.00. The DCG of the top-4 rows, which are the rows having high-quality scores in this baseline ranking example, is 13.38. The DCG of the entire list of search results 298 is 17.22. A normalized DCG (nDCG) may be calculated by dividing the DCG by an ideal DCG, which may be the maximum possible DCG at position p based on all documents that are relevant to the query. However, the nDCG need not be calculated in the examples described herein that use the same set of documents as search results. Although this disclosure describes calculating scores for rankings in a particular manner, this disclosure contemplates calculating scores for rankings in any suitable manner.

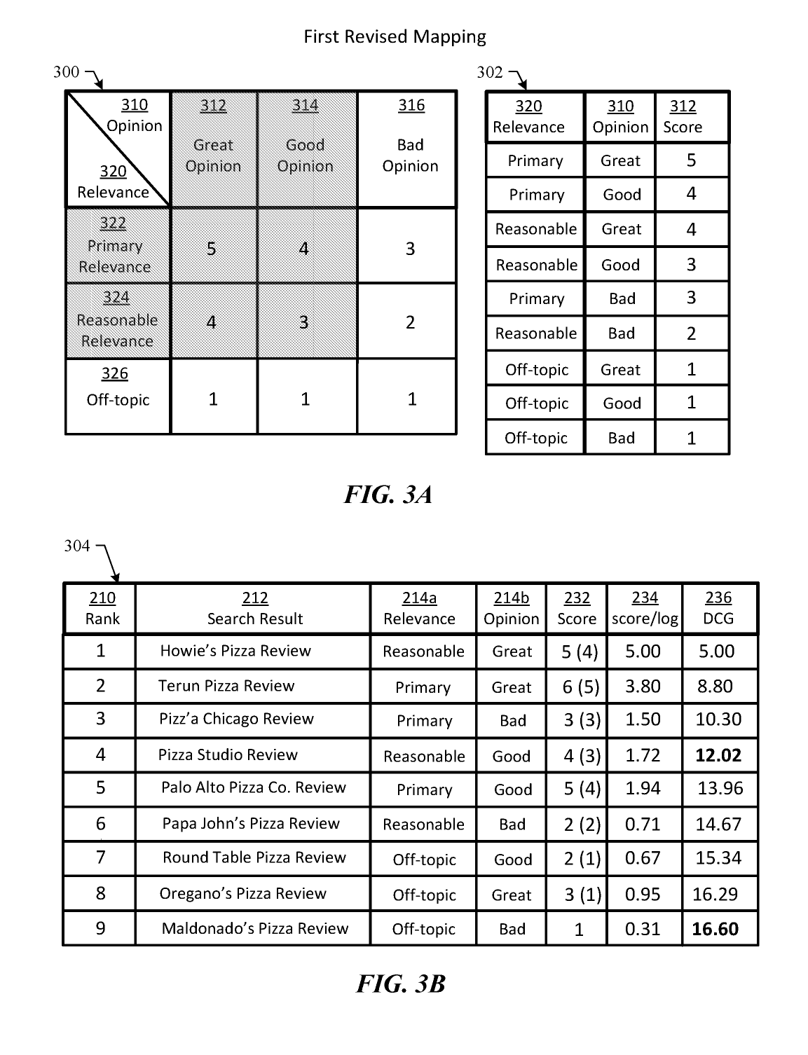

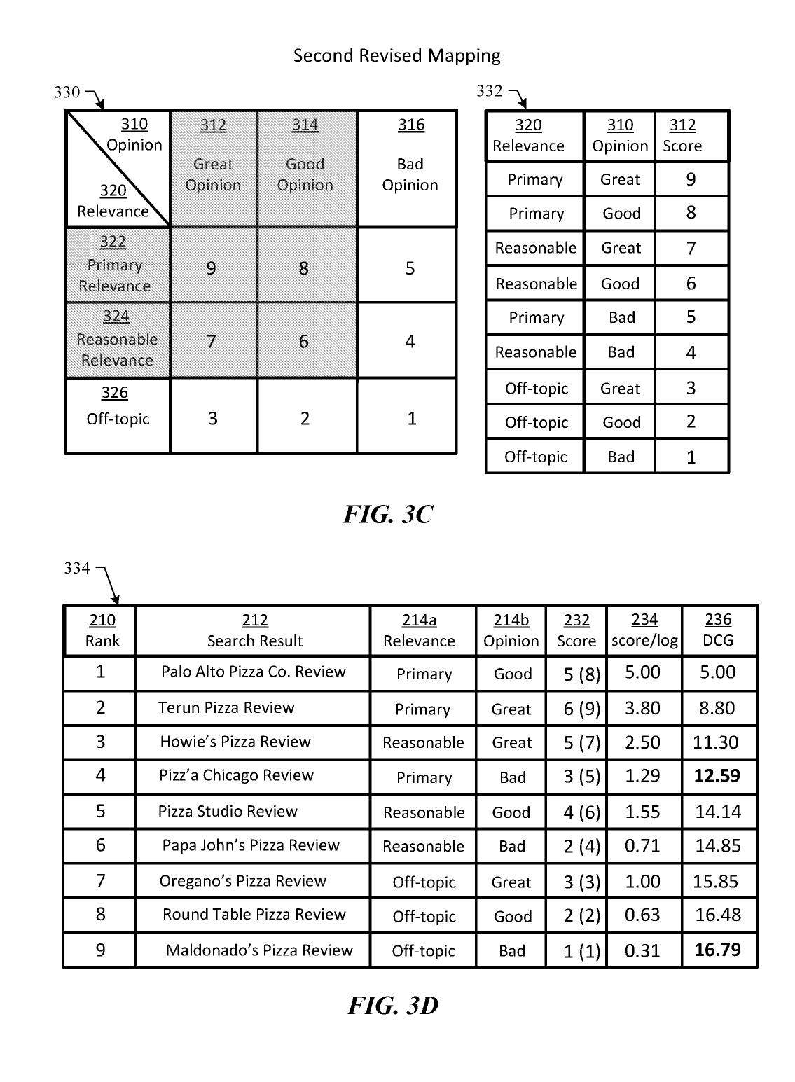

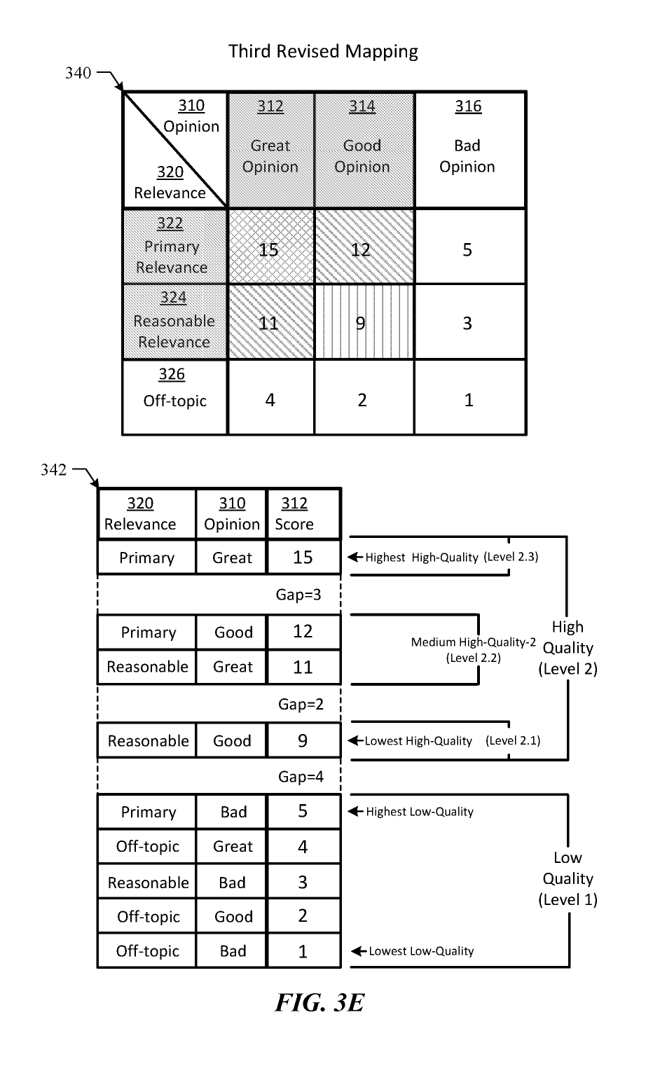

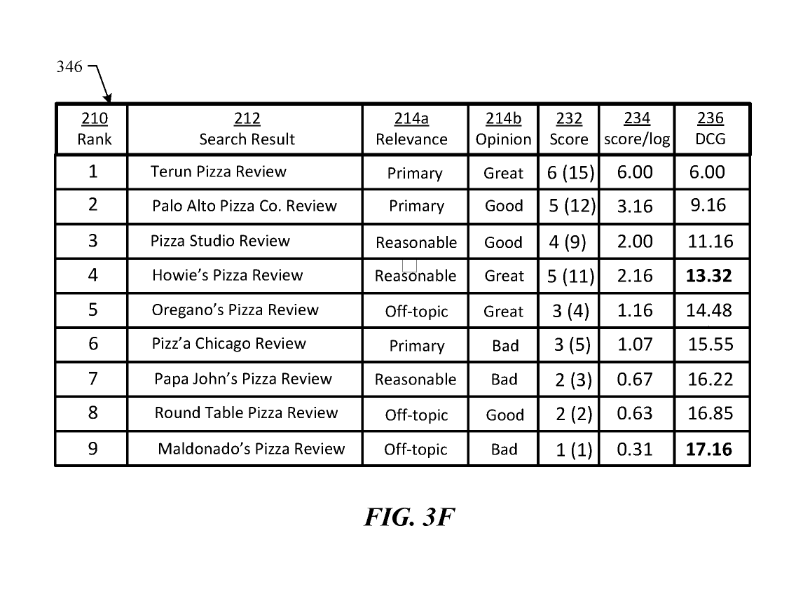

FIG. 3A illustrates an example first revised mapping scheme 300 of qualitative labels to scores. The first revised mapping scheme 300 is an example of a mapping that may be generated based on intuition or experiments. The first revised mapping scheme 300 assigns the lowest score to search results that include an off-topic content-relevance label 326, but assigns a score of 2 to the bad opinion, reasonable relevance) combination, and a score of 3 to the (primary relevance, bad opinion) combination. Thus, the first revised mapping 300 penalizes low-quality relevance more than low-quality opinions. The scores of the first revised mapping 300 may be used as a basis for comparison to search results generated by mappings that have different score values for the qualitative labels to evaluate whether such mappings improve the quality of search results. The revised mapping scheme 300 has three columns for the three labels that represent opinion-quality 310: a great opinion column 312, a good opinion column 314, and a bad opinion column 316. The mapping 300 also has three rows for the three labels that represent content-relevance 320: a primary relevance row 322, a reasonable relevance label 324, and an off-topic relevance label 326. The scores in the revised mapping scheme 300 include high-quality scores, which are shaded and correspond to high and medium-quality labels, and low-quality scores, which correspond to at least one low-quality label. The high-quality scores are: (primary, great)=5, (primary, good)=4, (reasonable, good)=3, and (reasonable, great)=4. The low-quality scores are (off-topic, great)=1, (primary, bad)=3, (off-topic, good)=1, (reasonable, bad)=2, and (off-topic, bad)=1. The first revised mapping 300 is also shown as a mapping table 302 having a relevance label column 320, an opinion label column 310, and a score column 312.

FIG. 3B illustrates example search results 304 generated using the first revised mapping 300 of FIG. 3A. Each of the search results 304 is associated with a score 232 determined from a relevance label 214a and an opinion label 214b associated with the search result 212 using the first revised mapping scheme 300. The scores 304 are in the order 5, 6, 3, 4, 5, 2, 2, 3, 1 from highest-ranking to lowest-ranking. The DCG of the highest-ranked search result (at rank 1) is 5.00. The DCG of the top-4 rows, which are the rows having high-quality scores in this example, is 12.02. The DCG of the entire list of search results 304 is 16.60.

FIG. 3C illustrates an example second revised mapping 330 of qualitative labels to scores. The second revised mapping 330 is an example of a mapping that may be generated by increasing the values of the scores while assigning lower scores to off-topic search results than to bad-opinion search results so that search results having low-quality content-relevance are penalized more than search results having low-quality opinions. Different values are assigned to each off-topic score to better distinguish between great, good, and bad opinions. The mapping 330 has three columns for the three labels that represent opinion-quality 310: a great opinion column 312, a good opinion column 314, and a bad opinion column 316. The mapping 330 also has three rows for the three labels that represent content-relevance 320: a primary relevance row 322, a reasonable relevance label 324, and an off-topic relevance label 326. The scores in the mapping 330 include high-quality scores, which are shaded and correspond to high and medium-quality labels, and low-quality scores, which correspond to at least one low-quality label. The high-quality scores are: (primary, great)=9, (primary, good)=8, (reasonable, good)=6, and (reasonable, great)=7. The low-quality scores are (off-topic, great)=3, (primary, bad)=5, (off-topic, good)=2, (reasonable, bad)=5, and (off-topic, bad)=1. The second revised mapping 330 is also shown as a mapping table 332 having a relevance label column 320, an opinion label column 310, and a score column 312.

FIG. 3D illustrates example search results 334 generated using the second revised mapping 330 of FIG. 3C. Each of the search results 334 is associated with a score 232 determined from a relevance label 214a and an opinion label 214b associated with the search result 212 using the second revised mapping 330. The scores 334 are in the order 8, 9, 7, 5, 6, 4, 3, 2, 1. However, for purposes of calculating the DCG, the corresponding values of the baseline scores from FIG. 3B are shown in the score column 232. The baseline scores are 5, 6, 5, 3, 4, 2, 3, 2, 1 from highest-ranking to lowest-ranking. The baseline scores are shown in the score column 232 followed by the corresponding scores from the mapping 330 in parentheses. The DCG of the highest-ranked search result (at rank 1) is 5.00. The DCG of the top-4 rows, which are the rows having high-quality scores in this example, is 12.59. The DCG of the entire list of search results 334 is 16.79. Comparing the DCG values to those in FIG. 3B, the second revised mapping 330 of FIG. 3C can be seen to produce greater DCG values and thus higher-quality search results than the first revised mapping 300 of FIG. 3A.

FIG. 3E illustrates an example third revised mapping 340 of qualitative labels to scores. The third revised mapping 340 is an example of a mapping that may be generated by introducing a gap between scores of different quality levels by modifying adjacent scores have non-consecutive values. The mapping 340 has three columns for the three labels that represent opinion-quality 310: a great opinion column 312, a good opinion column 314, and a bad opinion column 316. The mapping 340 also has three rows for the three labels that represent content-relevance 320: a primary relevance row 322, a reasonable relevance label 324, and an off-topic relevance label 326. The scores in the mapping 340 include high-quality scores, which have line patterns as backgrounds, and correspond to high and medium-quality labels, and low-quality scores, which correspond to at least one low-quality label. The high-quality scores are further divided into a highest high-quality score (15) having a cross-hatched background, medium high-quality scores (11 and 12) having diagonal-line backgrounds, and a lowest high-quality score (9) having a vertical-line background. The adjacent scores in different quality levels within the high-quality scores are separated by gaps. There is a gap of 3 between the greatest medium high-quality score (12) and the highest high-quality score (15). Further, there is a gap of 2 between least medium high-quality score (11) and the lowest high-quality score (9). There is also a gap of 4 between the greatest low-quality score (5) and the least high-quality score 9. Thus, the high-quality scores are: (primary, great)=15, (primary, good)=12, (reasonable, good)=9, and (reasonable, great)=11. The low-quality scores are (off-topic, great)=4, (primary, bad)=5, (off-topic, good)=2, (reasonable, bad)=3, and (off-topic, bad)=1. The third revised mapping 340 is also shown as a mapping table 342 having a relevance label column 320, an opinion label column 310, and a score column 312. The gaps between the quality levels are shown in the mapping table 342. The quality levels may be numbered starting from the lowest quality level, and the numbering may be extended to identify nested quality levels. In this example, the low-quality level (corresponding to scores 1-5) is assigned the level number 1, and the high-quality level (corresponding to scores 0, 11, 12, and 15) is assigned the level number 2. Within the high-quality level are three sub-levels, including a lowest high-quality level, which is assigned the level number 2.1, a medium high-quality level, which is assigned the level number 2.2, and a highest high-quality level, which is assigned the level number 2.3. These quality levels correspond to the quality levels in the third revised mapping 340 described above. A gap of 4 has been introduced between the low-quality level (1) and the high-quality level (2). Within the high-quality level (2), a gap of 2 has been introduced between the lowest high-quality level and the medium high-quality level and a gap of 3 has been introduced between the medium high-quality level and the highest high-quality level.

FIG. 3F illustrates example search results 346 generated using the third revised mapping of FIG. 3A. Each of the search results 346 is associated with a score 232 determined from a relevance label 214a and an opinion label 214b associated with the search result 212 using the third revised mapping 340. The scores 346 are in the order 15, 12, 9, 11, 4, 5, 3, 2, 1. However, for purposes of calculating the DCG, the corresponding values of the baseline scores from FIG. 3B are shown in the score column 232. The baseline scores are 6, 5, 4, 5, 3, 3, 2, 2, 1 from highest-ranking to lowest-ranking. The baseline scores are shown in the score column 232 followed by the corresponding scores from the mapping 340 in parentheses. The DCG of the highest-ranked search result (at rank 1) is 6.00. The DCG of the top-4 rows, which are the rows having high-quality scores in this example, is 13.32. The DCG of the entire list of search results 346 is 17.16. Comparing the DCG values to those in FIG. 3D, the third revised mapping 340 of FIG. 3E can be seen to produce greater DCG values and thus higher-quality search results than the second revised mapping 330 of FIG. 3C.

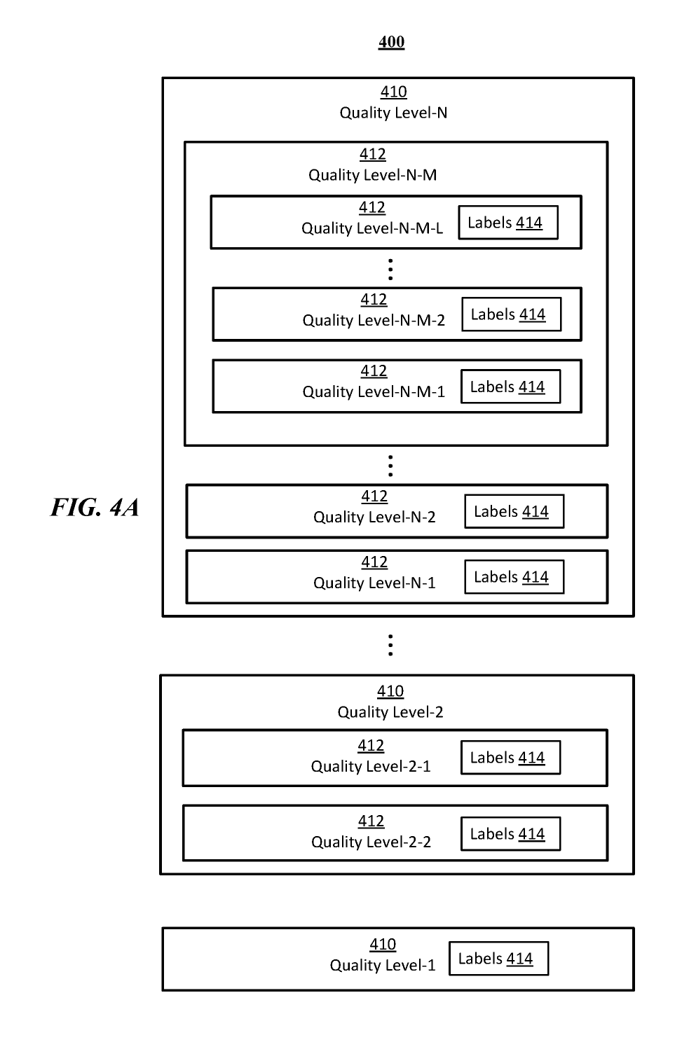

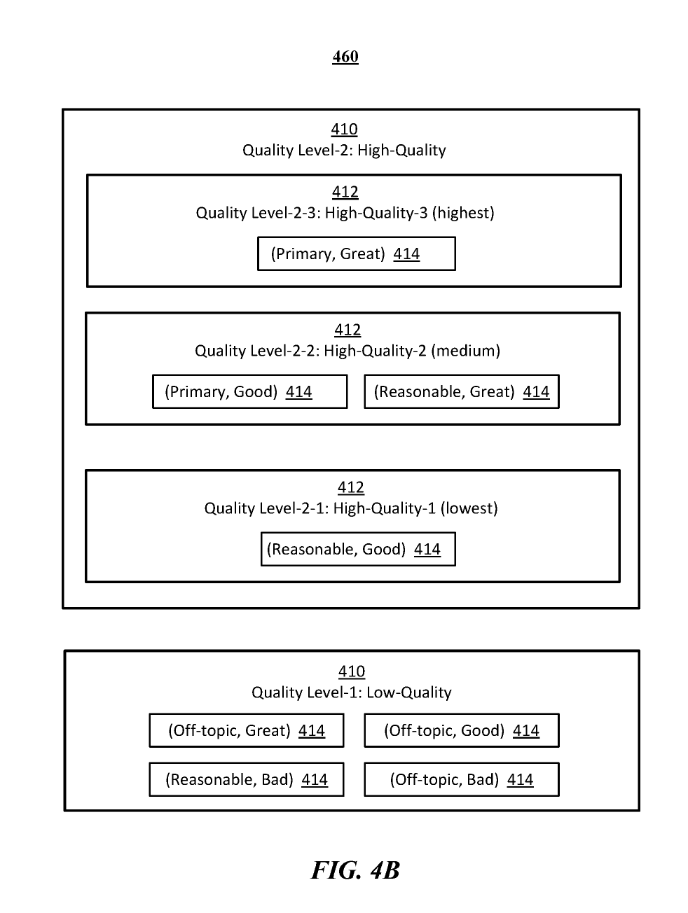

FIG. 4A illustrates example quality levels 400. The quality levels 400 include a Quality Level-1 410, which may have associated qualitative labels 414, a Quality Level-2 410, which may include two nested quality levels 412. The nested quality levels 412 include a Quality Level-2-1 412 and a Quality Level-2-2 412, each of which may be associated with labels 414. There may be additional quality levels numbered between Quality Level-2 410 and a Quality Level-N 410. The Quality Level-N 410 may include nested quality levels. The nested quality levels may include a Quality Level-N-1 412 and a Quality Level-N-2, each of which may have associated labels 414, and additional quality levels up to a Quality Level-N-M 412, which may include nested quality levels. The nested quality levels may include a Quality-Level-N-M-1 412 and a Quality Level-N-M-2 412 through a Quality Level N-M-L 312, each of which may be associated with labels 414.

FIG. 4B illustrates example quality levels 460. The quality levels 460 correspond to the quality levels shown in the mapping table 342 of FIG. 3E. The quality levels 460 include a Quality Level-1 410 and a Quality Level-2 410. The Quality Level-1 represents a low-quality level and is associated with qualitative label pairs (off-topic, great), (off-topic, good), (reasonable, bad), and (off-topic, bad) 414. The Quality-Level-2 represents a high-quality level and includes three nested quality levels. The nested quality levels include a Quality Level-2-1, which is a first high-quality level having a lowest quality in the high-quality levels, a Quality Level-2-2, which is a second high-quality level having a medium quality in the high-quality levels, and a Quality Level-2-3, which is a third high-quality level having a highest quality in the high-quality levels. Quality-Level-2-1 is associated with a (reasonable, good) label 414, Quality-Level-2-2 is associated with (primary, good) and (reasonable, great) labels 414, and Quality-Level-2-3 is associated with a (primary, great) label 414.

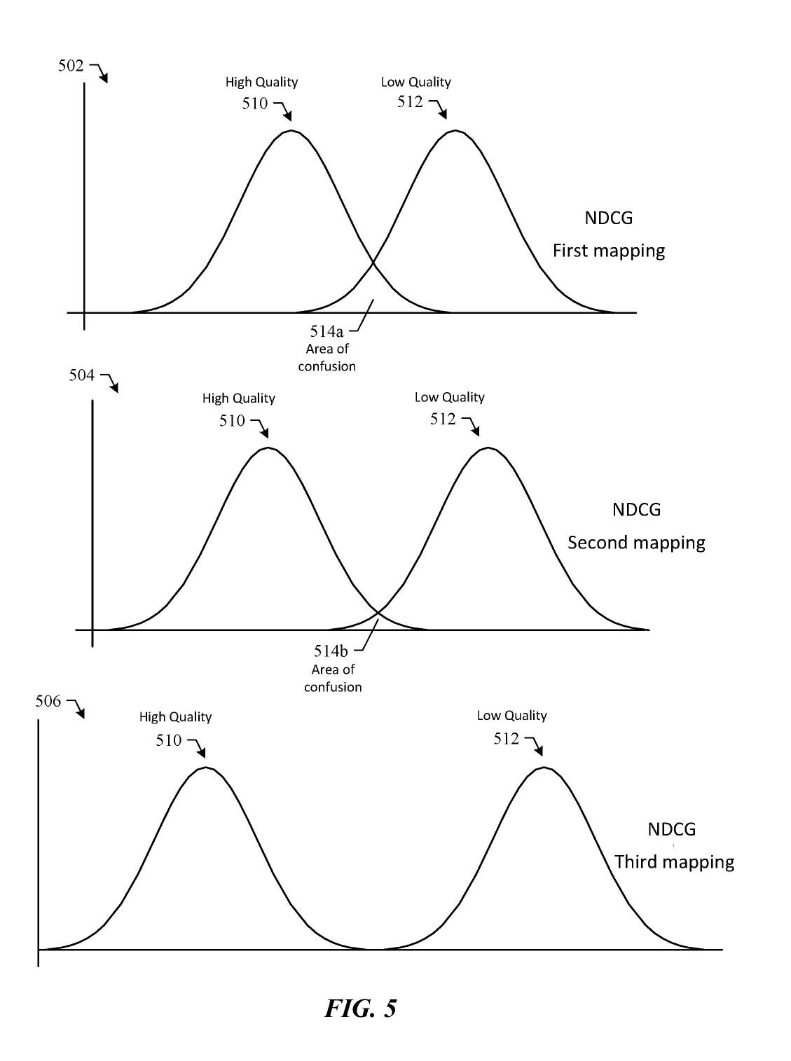

FIG. 5 illustrates example probability distributions corresponding to example label-to-score mappings. First probability distributions 502 correspond to the first revised mapping 300 of FIG. 3A. The first probability distributions 502 include a high-quality distribution 510 that represents nDCG values of high-quality search results and a low-quality distribution 512 that represents nDCG values of low-quality search results. The high-quality and low-probability distributions overlap at an area of confusion 514a, in which search results having low-quality label tuples (e.g., (reasonable, bad) having a score of 2) may be reversed with high-quality search results having similar scores (e.g., (reasonable, good) having a score of 3).

Second probability distributions 504 correspond to the second revised mapping 330 of FIG. 3C, in which the scores are distributed across a greater range than in the first revised mapping 300. In the second probability distributions 504, a high-quality distribution 510 is farther away from the low-quality distribution 512 than in the first probability distributions 502. Thus, the area of confusion 514b is smaller than the area of confusion 514a, and reversals between low-quality and high-quality search results are less likely than in the distributions 502.

Third probability distributions 506 correspond to the third revised mapping 340 of FIG. 3E, in which gaps have been introduced between scores on the boundaries between low and high-quality search results. In the third probability distributions 506, a high-quality distribution 510 is farther away from the low-quality distribution 512 than in the second probability distributions 502 so that there is little or no overlap between the distributions 510, 512. Thus, there is little or no area of confusion between the third distributions 506, and reversals between low-quality and high-quality search results are less likely than in the distributions 504.

The effect of increasing the gap as described above may be understood as follows. The machine-learning model is trained to generate rankings by comparing pairs of content items to determine which item of the pair should be ranked higher. The pair comparison approach represents the ranking problem as a classification problem. A binary classifier, which may be represented as a scoring function, is learned. The scoring function may generate the scores described in the mappings above for a given query and content item based on features of the content item. The machine learning model, once trained, can use the learned scoring function to predict the relevance and opinion level of content items.

The scoring function may be trained to minimize the average number of misclassified content item pairs by minimizing a loss function that represents the price paid for inaccuracy of classification predictions. More specifically, during the training process, the loss function may be applied to measure differences between the scoring function being trained and the scores assigned to the training data based on human trainer input. The training process adjusts the scoring function to minimize the loss function. The loss function may be based on the order of each pair of content items. For example, the value of the loss function may be based on the discounted cumulative gain calculated for a classification prediction. During the training process, a classification decision that produces a correct ranking yields a credit, while a classification decision that produces an incorrect ranking yields penalty. A penalty may be reversed (i.e., made up for) by another classification decision that reverses the incorrect ranking pair.

In particular embodiments, desired ranking results may be achieved by associating penalties with mistakes that would produce rankings different from the desired results. Penalties may be imposed by the loss function, and the loss function may determine penalties based on the differences between scores in the ranking table. Larger differences between groups, e.g., 2 or 3 score units, may reduce classification mistakes between the groups because the size of the difference corresponds to the size of the penalty. Accordingly, increased penalties may be imposed on classification mistakes by introducing a gap, i.e., difference greater than 1, between score groups that are desired to be ranked at different levels. For example, suppose there are two score levels, low-quality and high-quality, with the low-quality level corresponding to scores 1-5 and the high-quality level corresponding to scores 6-9. In the desired ranking results, content items that correctly belong to one group are not to be mistakenly classified into the other (incorrect) group. To prevent such classification mistakes, a gap >1 may be introduced into the scores. For example, to introduce a gap of 2 between the groups, the scores corresponding to the second group may be renumbered from 6-9 to 7-10. As another example, a gap of 3 may be introduced between the groups by renumbering the second group to 9-13.

A classification mistake may cause a loss that corresponds to the size of the gap, and larger losses may receive greater penalties than smaller losses, thereby discouraging classifications that result in larger losses. For example, if the mapping is changed so the high-quality group's scores are numbered from 9-13 instead of 6-9, then a mistake in which the content item having a correct score of 5 (Primary, Bad Opinion) is incorrectly assigned a score of 9 (Reasonable, Good Opinion), then a penalty of 4 points may be imposed by the loss function. A loss of 4 in the training process would be difficult to “make up” with correct reverse pairs to make the 9 to 5 loss acceptable as a correct pair that impacts the model being learned. For example, 4 pairs of 5 to 4, each worth 1 unit, would need to be classified to make up for the 4 point loss. Alternatively, 2 pairs of 5 to 3, each worth 2 units, would make up for the 4 point loss. However, classifying such 1 or 2 point pairs to make up for a loss may be difficult, because adjacent pairs in the training data may be difficult to classify. Larger gaps are easier for the classifier to classify. Thus, a mistake in classification that crosses a larger gap, e.g., a content item that should be scored as 5 is scored as 9, results in a more substantial penalty. Such a penalty essentially prevents the mistaken classification from impacting the model because of the difficulty of making up the loss. A mistake in classification that crosses a small gap, such as from 3 to 4 and remains in the same group (low-quality) does not substantially affect the rankings is not necessarily corrected.

The loss value for a classification in the training process may be calculated based on nDCG. nDCG may be calculated by a function based on the formula

$$D C {G}_{p} = {\sum }_{i = 1}^{p} \frac{{2}^{{score}_{i}} - 1}{{log}_{2} ( i + 1 )}$$

where i is the position of a content item in a ranking and scoreᵢ is the score determined for the content item at position i. For the purpose of understanding the effect of scoring changes such as introducing gaps between scores, it is sufficient to consider the 2^{score}^{ᵢ} term and ignore the other portions of the DCG formula shown above.

For example, the difference in nDCG values calculated for two “adjacent” ranking scores, such as 9 and 8 in the consecutive 1-9 mapping, is relatively small. These scores correspond to Primary, Great Opinion and Reasonable, Good Opinion. Since Primary, Great Opinion is the highest possible categorization, it may be considered a separate group from the next 3 highest scores (12, 11, and 9), e.g., a “great” group. For example, for the scores 9 and 8, nDCG(9) is approximately 2⁹, and nDCG(8) is approximately 2⁸. The difference, 2⁹-2⁸, is 2⁸ (=256). However, changing the mapping so that 9 is replaced with 15 and 8 is replaced with 12 results in a larger gap between the two adjacent scores: 2^{15 -}2¹² is approximately 2¹⁵ (=28672). The training of the machine learning module focuses on this part for the loss. The greater loss resulting from the larger gap between 15 and 12 causes the model to be trained to maintain the correct ranking order between the item with a score of 15 and the item with a score of 8.

As described above, the content items to be ranked may be divided into two levels: A “low-quality” level having scores in the range 1-5, and a “high-quality” level having scores in the range 6-9 prior to re-mapping to widen the gaps, or 9-15 after re-mapping. Prior to re-mapping to widen the gaps, scores in the high-quality level, 6-9, were close to each other and to the 5 in the low-quality level, so mistakes could easily be made. After widening the gap between the low and high-quality levels by changing the high-quality level's range from 6-9 to 9-15, the training process is less likely to make mistakes, as discussed above. The distributions of low and high-quality scores are based on the classification features and can be visualized as distribution curves that partially overlap. The overlapping area between the high and low-quality distributions may be understood as an area of confusion 514 in which mistakes may be made. Widening the gaps in the mapping does not necessarily change the shapes of the distributions of low and high-quality scores, but does have a phase shift effect in which the low-quality 512 and high-quality 510 distributions become farther apart and consequently have a smaller overlapping area. When the distributions are farther apart, the classifier is less sensitive to mistakes because the overlapping area of confusion 514 is smaller.

In particular embodiments, classification mistakes may be made within the score range 1-5, in which items are classified with an incorrect score by mistake. For example, an item that should correctly be classified as score 2 may be incorrectly classified as score 3. This mistake is called a “Low to Low” mistake. This mistake is considered acceptable in the example mappings. Classification mistakes may also be made between the Low range (1-5) and the High range (6-9), in which items correctly classified as Low are mistakenly classified as High (or vice versa). This mistake is called a “Low to High” mistake or a “High to Low” mistake depending on the relative values of the scores. This mistake is considered undesirable and should be avoided in the example mapping. Classification mistakes may also be made within the score range 6-9, re-mapped to 9-15, in which items are classified with an incorrect score by mistake. For example, an item that should correctly be classified as score 9 may be incorrectly classified as score 10. This mistake is called a “High to High” mistake. This mistake is undesirable and should be avoided, except that mistakes between 11 and 12 may be considered acceptable in the example mapping.

In particular embodiments, as described above, the classifier's scoring function may be trained to minimize the average number of misclassified content item pairs by minimizing a loss function. During the training process, the loss function is applied to measure differences between the scoring function being trained and the scores assigned to the training data based on human trainer input. Since the loss function is being minimized, mistakes that result in relatively large values of the loss function are unlikely to be made. The pre-remapping value of the loss function loss(Low to High), which is the loss for a Low to High mistake, is much smaller than the post-remapping value loss(Low to High). Thus a Low to High mistake is unlikely to be made after remapping, since such a mistake would not minimize the loss function.

Mistakes within the low-quality group may be acceptable in the example discussed above. Thus, the example remapping has not changed the scores in the low-quality group, which remain 1-5. As a result, the loss for a mistake within the low-quality group, e.g., between two scores within the range 1-5, is much less than the loss for a mistake that changes the group of a content item (e.g., loss(Low to Low) <<loss(Low to High)).

In particular embodiments, mistakes within the high-quality group are undesirable in the example discussed above, except for mistakes between 11 and 12, which are acceptable. Thus, the example remapping has changed the scores in the high-quality group so that the high-quality scores other than 11 and 12 are separated by wider gaps. Within the high-quality group, gaps have been introduced between some of the scores so that content items are more accurately classified within that group. The remapped scores of the high-quality group are 9, 11, 12, and 15. A wider gap (of 2 points) has been introduced after the Reasonable, Good score of 9, so that the next higher score, which is Reasonable, Great, is 11 instead of 10. There is still a 1-point gap between Reasonable, Great (11) and Primary, Good (12), because mistakes between those two categories are acceptable (e.g., those two categories have similar importance in this example). A wider gap has been introduced between Primary, Good (12) and Reasonable, Great (15). Reasonable, Great (15) is the highest rating in this example, and therefore the most important score. Thus, a substantial gap of 3 points has been introduced between Reasonable, Great (15) and the second-highest rating, Primary, Good (12). Accordingly, the loss has changed from the original loss(9-8) to the re-mapped loss(15-12), which is much greater than the original loss. Thus a relatively large penalty of 15-12=3 may be imposed on a mistake between 15 and 12, and such mistakes are accordingly unlikely to occur.

In particular embodiments, the effect of modifying the mapping function to widen gaps may be evaluated using Normalized Discounted Cumulative Gain (nDCG) as described above. The resulting nDCG value may be used to determine whether to repeat the remapping process to further widen the gaps. For example, if the nDCG value is below a threshold quality level, then the remapping may be performed again. In a test based on evaluation of opinion quality in search results by humans, the percentage of how many posts returned are Great, Good, or Bad was evaluated. The Great opinion rate increased by 37%, the Good opinion rate decreased by 4%, and the Bad opinion rate decreased by 5%. These tests were run for 373 sample post-query pairs. The run time and memory usage did not substantially change with the widened gaps.

Re-mapping the qualitative rankings to a new set of numerical scores, which may generate the new mapping, may be done by renumbering the initial set of numerical scores to introduce a gap of 2 or more score points. The gap may be determined based on the median value of the scores, e.g., (max score-min score)/2. The gap may be based on the importance level of at least one of the groups or sub-groups separated by the gap.

In particular embodiments, the new DCG may be calculated based on a new ranking of search results that include a list of content items ranked using a new machine-learning model trained on the qualitatively-ranked results and the new set of numerical scores associated with the qualitatively-ranked results by the new mapping. If the new DCG indicates that the new ranking is improved in comparison to the initial ranking (e.g., the new DCG is greater than the old DCG), then the new mapping may be used instead of the initial ranking to rank search results. If the new DCG does not indicate that the new ranking is improved, then the re-mapping may be performed again to further widen the gaps between groups in the new numerical scores.

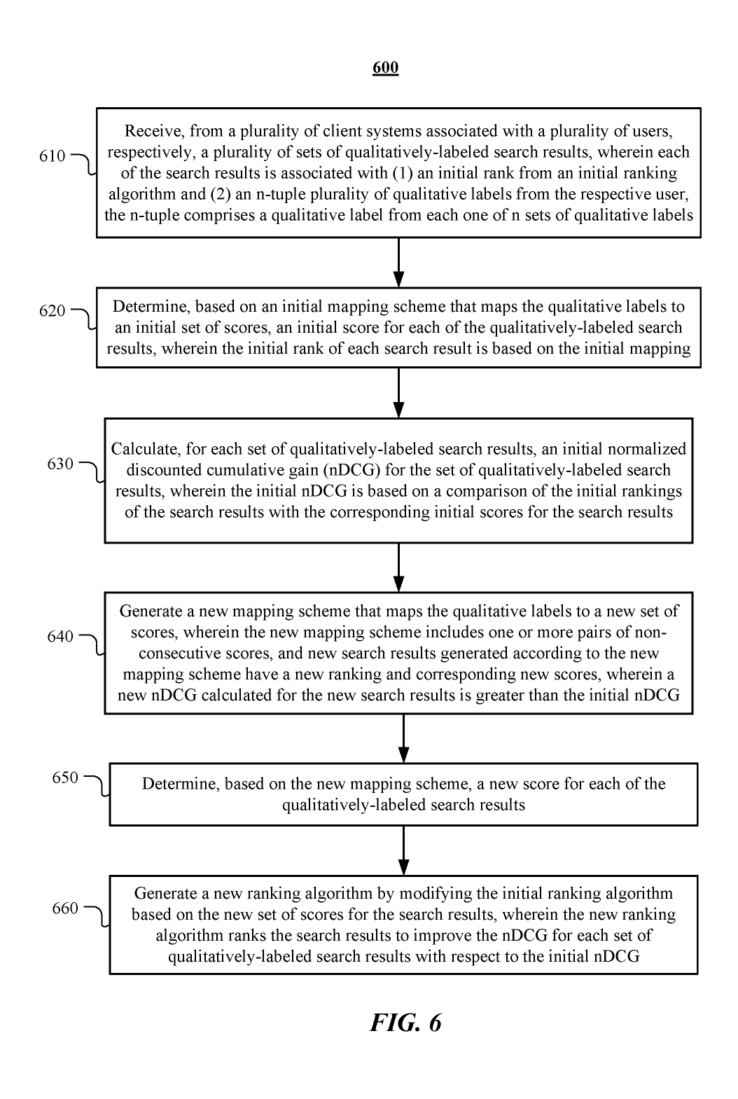

FIG. 6 illustrates an example method 600 for improving search result rankings. In particular embodiments, the method may identify a new mapping that produces search results having a new DCG than is an improvement over an initial DCG of an initial mapping. To do that, the new mapping is generated, and an initial DCG that represents a quality of the initial mapping is compared to a new DCG that represents a quality of a new mapping. The new DCG may be determined by training a new model based on the new mapping and calculating the new DCG based on search result rankings produced by the new model. If the new DCG is an improvement over the initial DCG, then the new mapping may be used instead of the initial mapping to train ranking models.

To train an initial model, a set of search results may be presented to a user (e.g., a trainer). Search results may include a set of (query, result) associations, where the result may be a post or other content item. The user selects one or more category labels for each of the search results (e.g., Primary Relevance, Good Opinion) to produce labeled search results. At this point, the information known for each search result is (query, search result, label(s)). This information may be referred to herein as the qualitatively-labeled search results.

Next, an initial DCG may be determined or received for search results that are generated based on the initial mapping. To determine the initial DCG, an initial machine-learning model may be trained based on the set of search results and the initial mapping. A set of search results may then be ranked using the initial machine-learning model to produce an initial ranking, and the initial DCG calculated for the initial ranking. Alternatively, the initial DCG may be received as input to the method. For example, the initial DCG may have been previously determined using a previously-trained initial machine-learning model.

Next, a new mapping may be generated, e.g., by introducing gaps between scores that correspond to different groups. To determine whether the new mapping is an improvement over the initial mapping, a new DCG may be determined for the new mapping. To calculate the new DCG, a new (or revised) machine-learning model may be trained on the qualitatively-ranked search results and the new set of numerical scores associated with the qualitatively-ranked results by the new mapping. More specifically, the labels may be converted to scores to produce scored search results. The machine-learning model may be trained on the scored search results. At this point, the information known for each search result is (query, search result, score). The label(s) may also be known, but no longer needed.

The method 600 may begin at step 610, where the social-networking system 160 may receive, from a plurality of client systems 130 associated with a plurality of users, respectively, a plurality of sets of qualitatively-labeled search results, wherein each of the search results is associated with (1) an initial rank from an initial ranking algorithm and (2) an n-tuple plurality of qualitative labels from the respective user, the n-tuple comprises a qualitative label from each one of n sets of qualitative labels. At step 620, the social-networking system 160 may determine, based on an initial mapping scheme that maps the qualitative labels to an initial set of scores, an initial score for each of the qualitatively-labeled search results, wherein the initial rank of each search result is based on the initial mapping. At step 630, the social-networking system 160 may calculate, for each set of qualitatively-labeled search results, an initial normalized discounted cumulative gain (nDCG) for the set of qualitatively-labeled search results, wherein the initial nDCG is based on a comparison of the initial rankings of the search results with the corresponding initial scores for the search results. At step 640, the social-networking system may generate a new mapping scheme that maps the qualitative labels to a new set of scores, wherein the new mapping scheme includes one or more pairs of non-consecutive scores, and new search results generated according to the new mapping scheme have a new ranking and corresponding new scores, wherein a new nDCG calculated for the new search results is greater than the initial nDCG. At step 650, the social-networking system may determine, based on the new mapping scheme, a new score for each of the qualitatively-labeled search results. At step 660, the social-networking system may generate a new ranking algorithm by modifying the initial ranking algorithm based on the new set of scores for the search results, wherein the new ranking algorithm ranks the search results to improve the nDCG for each set of qualitatively-labeled search results with respect to the initial nDCG. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for improving search result rankings including the particular steps of the method of FIG. 6, this disclosure contemplates any suitable method for improving search result rankings including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Social Graphs

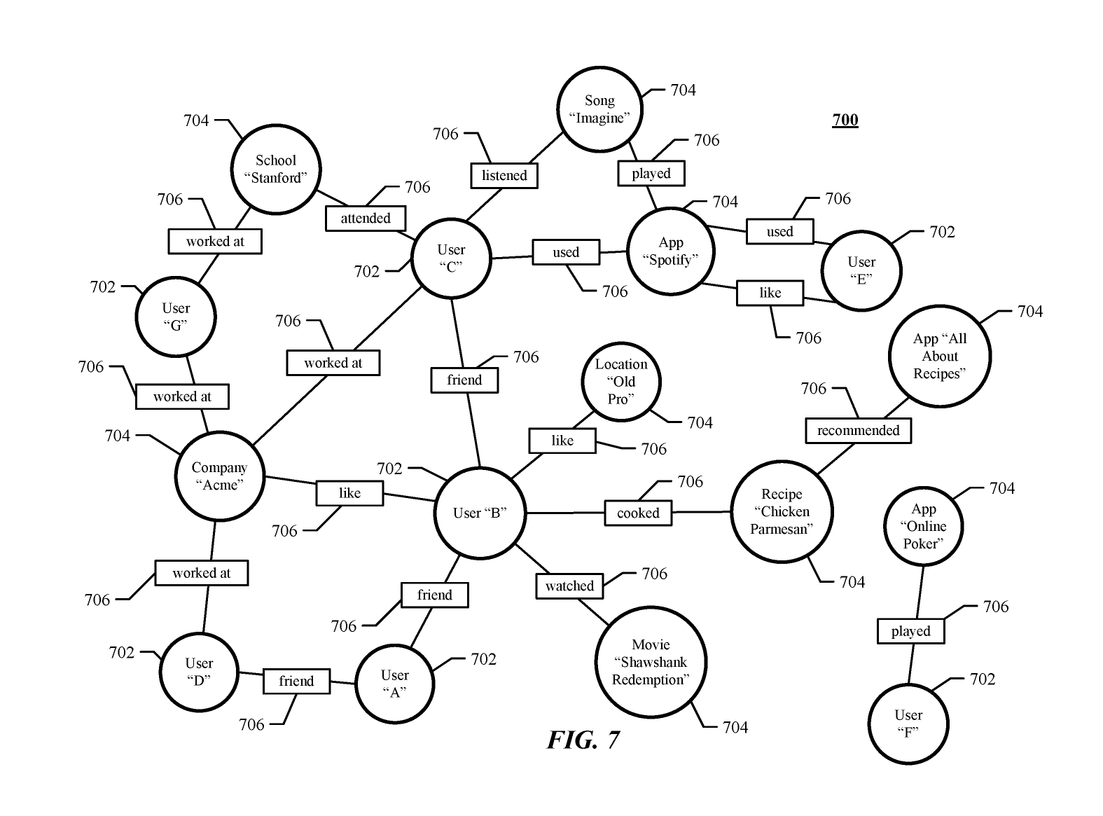

FIG. 7 illustrates example social graph 700. In particular embodiments, social-networking system 160 may store one or more social graphs 700 in one or more data stores. In particular embodiments, social graph 700 may include multiple nodes—which may include multiple user nodes 702 or multiple concept nodes 704—and multiple edges 706 connecting the nodes. Example social graph 700 illustrated in FIG. 7 is shown, for didactic purposes, in a two-dimensional visual map representation. In particular embodiments, a social-networking system 160, client system 130, or third-party system 170 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 160. In particular embodiments, a user node 702 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 160. Profile pages may also be hosted on third-party websites associated with a third-party system 170. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 706 connecting the first user's user node 702 to the second user's user node 702 in social graph 700 and store edge 706 as social-graph information in one or more of data stores 164. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 160 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social-networking system 160 may create an edge 706 between a user node 702 and a concept node 704 in social graph 700. As an example and not by way of limitation, a user viewing a concept-profile page (such as, for example, by using a web browser or a special-purpose application hosted by the user's client system 130) may indicate that he or she likes the concept represented by the concept node 704 by clicking or selecting a “Like” icon, which may cause the user's client system 130 to send to social-networking system 160 a message indicating the user's liking of the concept associated with the concept-profile page. In response to the message, social-networking system 160 may create an edge 706 between user node 702 associated with the user and concept node 704, as illustrated by “like” edge 706 between the user and concept node 704. In particular embodiments, social-networking system 160 may store an edge 706 in one or more data stores. In particular embodiments, an edge 706 may be automatically formed by social-networking system 160 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Systems and Methods

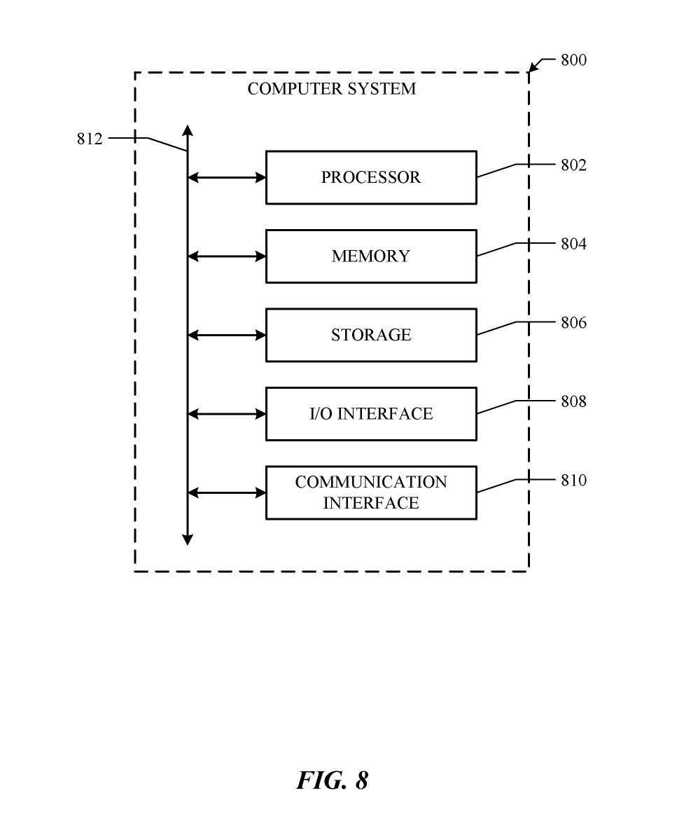

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing devices:
receiving, from a plurality of client systems associated with a plurality of users, respectively, a plurality of sets of qualitatively-labeled search results by the plurality of users, respectively, wherein each of the search results is associated with (1) an initial rank from an initial ranking algorithm and (2) an n-tuple of qualitative labels from the respective user, the n-tuple comprises a qualitative label from each one of n sets of qualitative labels, each set of qualitative labels represents a qualitative measure of search result quality on a quality scale ranging from low quality to high quality, and each qualitative label represents a level of quality of the associated search result according to the corresponding qualitative measure;
determining, by one or more of the computing devices, based on an initial mapping scheme that maps the qualitative labels to an initial set of scores, an initial score for each of the qualitatively-labeled search results, wherein the initial rank of each search result is based on the initial mapping scheme;
calculating, by one or more of the computing devices, for each set of qualitatively-labeled search results, an initial normalized discounted cumulative gain (nDCG) for the set of qualitatively-labeled search results, wherein the initial nDCG is based on a comparison of the initial rankings of the search results with the corresponding initial scores for the search results;
generating, by one or more of the computing devices, a new mapping scheme that maps the qualitative labels to a new set of scores, wherein the new mapping scheme is generated by modifying the initial mapping scheme, and wherein the new mapping scheme includes one or more pairs of non-consecutive scores, wherein each pair of non-consecutive scores corresponds to a pair of adjacent qualitative labels in one of the sets, and new search results generated according to the new mapping scheme have a new ranking and corresponding new scores, wherein a new nDCG calculated for the new search results is greater than the initial nDCG, and the new nDCG is based on a comparison of new rankings corresponding to the new search results with the corresponding initial scores for the search results, wherein the top-K new search results include at least as many high-quality search results as the top-K initial search results according to the qualitative labels associated with the new and initial search results;
determining, by one or more of the computing devices, based on the new mapping scheme, a new score for each of the qualitatively-labeled search results; and
generating, by one or more of the computing devices, a new ranking algorithm by modifying the initial ranking algorithm based on the new set of scores for the search results, wherein the new ranking algorithm ranks the search results to improve the nDCG for each set of qualitatively-labeled search results with respect to the initial nDCG.

2. The method of claim 1, wherein each set of qualitative labels includes at least a high-quality label to indicate a high-quality search result and a low-quality label to indicate a low-quality search result.

3. The method of claim 2, wherein the initial search results comprise one or more high-quality search results and one or more low-quality search results, and the qualitative label associated with each initial search result indicates whether the initial search result is low-quality or high-quality.

4. The method of claim 3, wherein the number of high-quality search results in the top-K new search results is greater than or equal to the number of high-quality search results in the top-K initial search results, and high-quality search results are identified according to their associated qualitative labels.

5. The method of claim 4, wherein the top-K new search results include each high-quality search result that is included in the initial search results.

6. The method of claim 1, wherein the initial nDCG is calculated for the top-K initial search results, and the new nDCG is calculated for the top-K new search results.

7. The method of claim 1, wherein the difference between the non-consecutive scores is the largest difference that corresponds to a mapping scheme for which the new nDCG is greater than the initial nDCG, and for which the new search results include at least as many high-quality search results as the initial search results.

8. The method of claim 1, wherein the difference between the non-consecutive scores is greater than or equal to a lower limit and less than an upper limit, and wherein the lower limit corresponds to a mapping scheme that causes the new nDCG to be greater than the initial nDCG and the top-K new search results to include at least as many high-quality search results as the top-K initial search results.

9. The method of claim 8, wherein the upper limit corresponds to a mapping scheme that causes the new search results to include more low-quality search results than are included in the initial search results.

10. The method of claim 1, wherein the qualitative labels in the pair of qualitative labels correspond to adjacent quality levels.

11. The method of claim 1, wherein K is a predetermined number of search results.

12. The method of claim 1, wherein the sets of qualitative labels include at least a first set and a second set, each of the first and second sets includes a high-quality label, a medium-quality label, and a low-quality label, wherein the medium-quality label indicates a medium level of quality between the high level of quality indicated by the high-quality label and the low level of quality indicated by the low-quality label, and wherein a combination of a label from the first set and a label from the second set is mapped to either high-quality to indicate a high level of quality of a search result or low-quality to indicate a low level of quality of a search result.

13. The method of claim 12, wherein the sets of qualitative labels include a content-relevance label set, and the content-relevance label set includes a primary relevance label indicating a high level of quality, a reasonable relevance label indicating a medium level of quality, and an off-topic relevance label indicating a low level of quality.

14. The method of claim 12, wherein the qualitative labels include an opinion-quality label set, and the opinion-quality label set includes a great opinion label indicating a high level of quality, a good opinion label indicating a medium level of quality, and a bad-opinion label indicating a low level of quality.

15. The method of claim 1, wherein the initial set of scores consists of consecutive scores.

16. One or more computer-readable non-transitory storage media embodying software that is operable when executed to:
receive, from a plurality of client systems associated with a plurality of users, respectively, a plurality of sets of qualitatively-labeled search results by the plurality of users, respectively, wherein each of the search results is associated with (1) an initial rank from an initial ranking algorithm and (2) an n-tuple of qualitative labels from the respective user, the n-tuple comprises a qualitative label from each one of n sets of qualitative labels, each set of qualitative labels represents a qualitative measure of search result quality on a quality scale ranging from low quality to high quality, and each qualitative label represents a level of quality of the associated search result according to the corresponding qualitative measure;
determine, based on an initial mapping scheme that maps the qualitative labels to an initial set of scores, an initial score for each of the qualitatively-labeled search results, wherein the initial rank of each search result is based on the initial mapping scheme;
calculate, for each set of qualitatively-labeled search results, an initial normalized discounted cumulative gain (nDCG) for the set of qualitatively-labeled search results, wherein the initial nDCG is based on a comparison of the initial rankings of the search results with the corresponding initial scores for the search results;
generate a new mapping scheme that maps the qualitative labels to a new set of scores, wherein the new mapping scheme is generated by modifying the initial mapping scheme, and wherein the new mapping scheme includes one or more pairs of non-consecutive scores, wherein each pair of non-consecutive scores corresponds to a pair of adjacent qualitative labels in one of the sets, and new search results generated according to the new mapping scheme have a new ranking and corresponding new scores, wherein a new nDCG calculated for the new search results is greater than the initial nDCG, and the new nDCG is based on a comparison of new rankings corresponding to the new search results with the corresponding initial scores for the search results, wherein the top-K new search results include at least as many high-quality search results as the top-K initial search results according to the qualitative labels associated with the new and initial search results;
determine, based on the new mapping scheme, a new score for each of the qualitatively-labeled search results; and
generate a new ranking algorithm by modifying the initial ranking algorithm based on the new set of scores for the search results, wherein the new ranking algorithm ranks the search results to improve the nDCG for each set of qualitatively-labeled search results with respect to the initial nDCG.

17. The media of claim 16, wherein each set of qualitative labels includes at least a high-quality label to indicate a high-quality search result and a low-quality label to indicate a low-quality search result.

18. A system comprising: one or more processors; and one or more computer-readable non-transitory storage media coupled to one or more of the processors and comprising instructions operable when executed by one or more of the processors to cause the system to:
receive, from a plurality of client systems associated with a plurality of users, respectively, a plurality of sets of qualitatively-labeled search results by the plurality of users, respectively, wherein each of the search results is associated with (1) an initial rank from an initial ranking algorithm and (2) an n-tuple of qualitative labels from the respective user, the n-tuple comprises a qualitative label from each one of n sets of qualitative labels, each set of qualitative labels represents a qualitative measure of search result quality on a quality scale ranging from low quality to high quality, and each qualitative label represents a level of quality of the associated search result according to the corresponding qualitative measure;
determine, based on an initial mapping scheme that maps the qualitative labels to an initial set of scores, an initial score for each of the qualitatively-labeled search results, wherein the initial rank of each search result is based on the initial mapping scheme;
calculate, for each set of qualitatively-labeled search results, an initial normalized discounted cumulative gain (nDCG) for the set of qualitatively-labeled search results, wherein the initial nDCG is based on a comparison of the initial rankings of the search results with the corresponding initial scores for the search results;
generate a new mapping scheme that maps the qualitative labels to a new set of scores, wherein the new mapping scheme is generated by modifying the initial mapping scheme, and wherein the new mapping scheme includes one or more pairs of non-consecutive scores, wherein each pair of non-consecutive scores corresponds to a pair of adjacent qualitative labels in one of the sets, and new search results generated according to the new mapping scheme have a new ranking and corresponding new scores, wherein a new nDCG calculated for the new search results is greater than the initial nDCG, and the new nDCG is based on a comparison of new rankings corresponding to the new search results with the corresponding initial scores for the search results, wherein the top-K new search results include at least as many high-quality search results as the top-K initial search results according to the qualitative labels associated with the new and initial search results;
determine, based on the new mapping scheme, a new score for each of the qualitatively-labeled search results; and
generate a new ranking algorithm by modifying the initial ranking algorithm based on the new set of scores for the search results, wherein the new ranking algorithm ranks the search results to improve the nDCG for each set of qualitatively-labeled search results with respect to the initial nDCG.

19. The system of claim 18, wherein each set of qualitative labels includes at least a high-quality label to indicate a high-quality search result and a low-quality label to indicate a low-quality search result.
